(19) United States
(12) Patent Application Publication
(10) Pub. No.: US 2007/0141535 A1
(43) Pub. Date: Jun. 21, 2007

(54) Supporting and strengthening element for dental prostheses or crown restorations

(76) Inventor: Paolo Baldissara, Imola (Bologna) (IT)

Correspondence Address: PEARNE & GORDON LLP, 1801 EAST 9TH STREET, SUITE 1200, CLEVELAND, OH, 44114-3108, US

(21) Appl. No.: 11/698,454

(22) Filed: Jan. 26, 2007

(30) Foreign Application Priority Data
Jul. 29, 2005 (IT) BO2005A000515

(51) Int. Cl. A61C 5/08

(52) U.S. Cl. 433/220

(57) ABSTRACT

A supporting or strengthening element (1) for dental prostheses or crown restorations made of a composite material consisting of a matrix (2) in which is embedded at least one solid phase (3) appropriately distributed in it, has a total length divided into at least three different sections (4, 5, 8), namely an apical section (4), a crown section (8) and an intermediate section (5); the sections (4, 5, 8), preferably equal in length, have uniform flexural and/or torsional rigidity obtained by a combination of different local geometries and different flexural and/or torsional elasticity moduli. The different elasticity moduli of the individual sections (4, 5, 8) are obtained by a suitably differentiated distribution of the solid phases (3) in the body of the matrix (2).

### BACKGROUND OF THE INVENTION

This invention relates to a supporting and strengthening element for dental prostheses or crown restorations. More specifically, the supporting element has a heterogeneous, composite structure basically consisting of a matrix of a suitable base material in which the solid phases of several other materials are embedded, said phases being appropriately located and distributed in the body of the matrix.

Already known to prior art in this field are supporting and strengthening elements for dental prostheses or crown restorations having a composite structure consisting of a resin matrix with which one or more solid phases in the form of different crystals or fibers are associated.

One solution of this type is disclosed for example in document U.S. Pat. No. 6,132,215 where reference is made to matrices made of polymer resins consisting, in particular, of polyester, epoxy, vinyl-ester, acrylic, bis-acrylic and cyano-ester resins; reinforced with carbon, aramide or polyethylene fibers, or even tungsten, ceramic, boron, quartz or glass fibers, embedded in the matrix.

Usually, the fibers are used in varying combinations and forms to make dental composites that vary in modulus of elasticity from one product to another to provide a range of products from which the one having the properties most suitable to treat any specific clinical case can be chosen.

This approach to production, although reasonably satisfactory, does not specify how these properties should vary and is not therefore able to provide optimum rigidity conditions to confer rigidity, on the one hand, needed to stabilize the core so that it can resist cyclic chewing forces, and flexibility on the other, just as important to prevent fracturing of certain parts of the tooth, such as the root, for example, weakened by prior treatment and/or by decay (for example, “flared canals” as they are known in international literature, caused by existing root canal posts or endodontic restorations to be substituted or by deep caries).

### SUMMARY OF THE INVENTION

The main aim of this invention is to overcome the above mentioned problems by structuring the supporting elements in such a way as to confer stress resistance, especially flexural stress resistance, that is as uniform as possible along the full length of the supporting element, irrespective of the cross section size or diameter of the element.

Another aim of the invention is to provide the possibility of modulating the degree of rigidity of the supporting elements within a wide range of values from which the choice most suitable for any specific need can be made.

In accordance with the invention, these aims are achieved by supporting elements comprising sections of characteristic length whose local structure is adapted to confer on the material moduli of elasticity that are variable and locally correlated with the geometrical shape characteristics of the supporting element.

### BRIEF DESCRIPTION OF THE DRAWINGS

The technical characteristics of the invention according to the above-mentioned aim may be easily inferred from the contents of the claims herein, especially claim 1, and any of the claims that depend, either directly or indirectly, on claim 1.

The advantages of the invention are more apparent from the detailed description which follows, with reference to the accompanying drawings which illustrate a preferred embodiment of the invention provided merely by way of example without restricting the scope of the inventive concept, and in which:

FIG. 1 is an axial cross section of a supporting or strengthening element according to the invention;

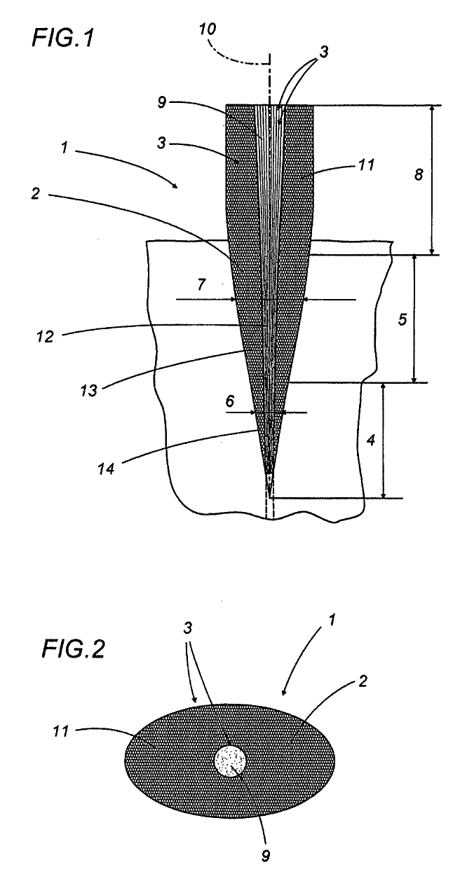

FIG. 2 is a view of the supporting or strengthening element of FIG. 1 cut transversely to its axis;

FIGS. 3A and 3B show how the crown section of the supporting element may incorporate a portion with a very wide cross section which serves as a core whose elasticity modulus is the lowest in the whole element;

FIGS. 4, 5 and 6 illustrate some preferable embodiments of the post, showing the related geometrical proportioning parameters.

### DESCRIPTION OF THE PREFERRED EMBODIMENTS

With reference to the accompanying drawings, the numeral 1 denotes a supporting or strengthening element for dental prostheses or crown restorations, made of a composite material consisting of a matrix 2 in which are embedded solid phases 3 appropriately formed and distributed in the body of the matrix 2.

The matrix 2 is made preferably of a resin 13 selected for example from one of the numerous families of thermo or photo-polymerizable resins such as polyester resins, epoxy resins, acrylic resins, bis-acrylic resins, cyano-ester resins, urethane-methacrylate resins, phenolic resins, polyphenylene sulphide (PPS) resins, polyetheretherketone, PEEK) resins. Thus, the posts may also be manufactured using resins selected from the family of thermoplastic resins, in addition to the typical thermo- or photo-polymerizable ones.

The above list of the resins most commonly used in composite material technology is not exhaustive, however, since the matrix 2 may obviously be made from a metal or metal-based material, a ceramic or ceramic-based material or even a glass or glass-based material.

The solid phases 3 embedded in the matrix 2 consist preferably of synthetic fibers of various kinds and/or of solid crystals also known as “whiskers” in the jargon of the trade, these being preferably coated with silica nanoparticles. Highly specific materials such as carbon nanotubes might also be used, either alone or in combination with the other fibers mentioned in this text. Preferably, boron-tungsten, carbon, quartz, glass, ceramic, silicon carbide, polyethylene or aramide fibers are used.

The supporting element 1 is preferably used as a prefabricated root canal post designed to be inserted into a dental canal 14 of a patient.

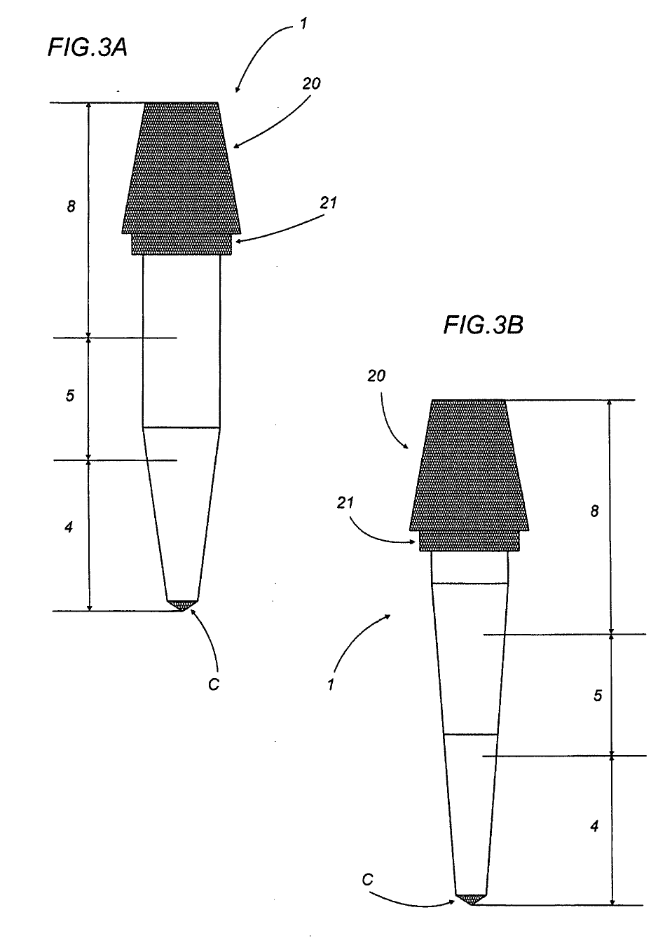

Following the anatomy of the dental canal 14, the supporting element may have an oblong cross section in the transversal plane (FIG. 2).

In fact, it is known that the anatomy of the root canal is such that its cross section is shaped more like an ellipse than a circle. Above all in certain single-root dental elements (incisors, canines, premolars) the cross section after endodontic treatments is substantially oblong in shape. Therefore, to correctly perform its function correctly, the post must fit into the dental cavity or root canal 14 as snugly as possible. That means that the clearance between the walls of the post 1 and those of the dental cavity 14 must be as small as possible so as to minimize the layer of adhesive cement necessary to fix the post 1 to the tooth.

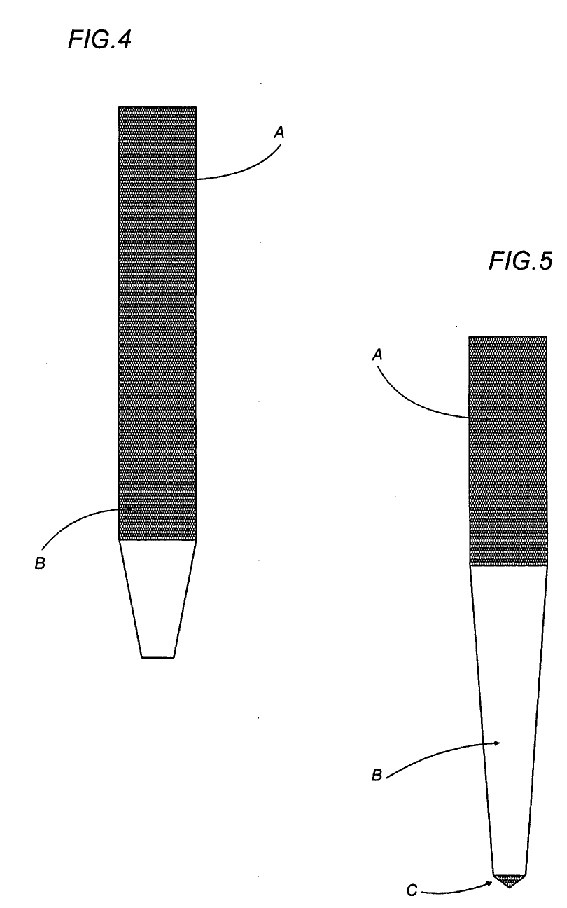

The oblong cross section of the supporting element or post 1 may be either elliptic or polygonal. Proceeding along the longitudinal axis 10 of the post, the oblong cross section also has cross sections of variable size and, more specifically, increasing in size from the apical area to the crown area of the tooth. The crown area may have a very wide cross section so as to reproduce the core 20 supporting the prosthetic crown which is thus incorporated in the post without having to add composite material to the post after inserting it into the canal (FIGS. 3A; 3B). The abutment base 21 of the core may be variously shaped to match the root surface exactly thereby making the restoration much more resistant to the stress caused by chewing.

The structure of the supporting or strengthening element 1 is designed in such a way that its flexural and/or torsional strength is as constant as possible along the full length of the post independently of variations in cross section size.

In practice, this result is obtained by structuring the post 1 in such a way that the elasticity modulus is higher where the diameter of the post is smaller and, vice versa, the elasticity modulus is lower where the diameter of the post is larger. In the context of this concept, the total length of the post may be considered as ideally subdivided into at least three characteristic sections 4, 5 and 8 in which uniform rigidity is achieved by increasing the modulus of elasticity to compensate for smaller transversal dimensions of the post. It should be noticed that the elasticity moduli of the different sections are the mean moduli, given the per se heterogeneous structure of each of the sections 4, 5 and 8.

Thus, in the first section 4, corresponding to the apical portion where the mean diameter of the cross section is the smallest, the elasticity modulus is the highest. In the third section 8, corresponding to the crown portion where the diameter is the largest, especially if core-shaped (FIGS. 3A and 3B), the elasticity modulus is the lowest; and finally, in the second section 5, corresponding to the portion in between the previous two, where the value of the mean diameter is intermediate between the apical and crown diameters, the elasticity modulus is lower than the modulus of the apical section 4 and higher than the modulus of the crown section 8. It should be noticed that in the section 8, the elasticity modulus may be up to more than 50% less than the mean value of the modulus of the composites used in the portions 4 and 5.

The difference in elasticity modulus in the different sections 4, 5 and 8 of the post 1 may be obtained in various ways. The value of the elasticity modulus may be obtained by varying the spatial arrangement of the fibers in the body of the matrix 2 from one section to the other, or by varying the orientation and direction of the different fiber fractions which may be arranged in such a way as to form two- or three-dimensional patterns of varying complexity.

It is also possible to vary the volumetric ratios (reciprocal densities) of the phases in the different sections 4, 5 and 8 of the post: for example, where the section is wider, there may be parallel fibers 9, spaced to a varying extent and/or dispersed in varying degrees in the body of the matrix 2, or there may be oblique fibers, both parallel 9 and oblique 11, even interwoven. In other words, the fibers 11 arranged obliquely and even interwoven can lower the flexural elasticity modulus: this property may be applied to suitably modulate the longitudinal elasticity modulus of the crown section 8.

Where the cross section of the post 1 is narrower, the layer of obliquely arranged fibers 11 may be partially or totally eliminated from the tapered part of the post 1. Thus, this part consists almost entirely or entirely of the inner parallel fibers 9 only which, thanks to their spatial arrangement, maintain their higher modulus.

Longitudinal variations in the elasticity modulus may also be influenced by varying the density, type and arrangement of the materials or by adding crystals having different properties and also, like the fibers, forming part of the solid phases 3 dispersed in the matrix 2.

Described below are some examples of composite posts 1 made according to this invention:

a composite post obtained by combining a resin matrix 2 with quartz fibers 9 positioned in the vicinity of and parallel to the longitudinal axis 10 and surrounded by quartz or glass fibers 11 biaxially interwoven in braid-like fashion; or

a composite post of materials obtained by combining a resin matrix 2 with high modulus (HM) carbon fibers 9 positioned in the vicinity of and parallel to the longitudinal axis 10 and surrounded by fibers 11, biaxially interwoven in braid-like fashion, of high strength (HS) carbon, quartz, ceramic or glass; or

a composite post obtained by combining a resin matrix 2 with boron/tungsten fibers 9 positioned in the vicinity of and parallel to the longitudinal axis 10 and surrounded by fibers 11, biaxially interwoven in braid-like fashion, of carbon and/or quartz and/or glass and/or ceramic.

In the three examples indicated above, the fibers 9 and 11 of each of the post structures may be present in all possible proportions and in all possible spatial arrangements.

Within a single combination in which the phases 3 are uniformly present along the full length of the post, the longitudinal elasticity moduli can be gradually changed by varying the density of the fibers in the matrix 2, for example, by positioning in the apical section 4 longitudinal parallel fibers 9 in closely compacted bundle form at the longitudinal axis 10 of the post 1; while in the intermediate section 5, the fibers may be not only longitudinal and parallel fibers 9—for example continuing directly from the previous section—but also transversal fibers 11 positioned around the fibers 9 but dispersed to a greater extent in the body of the surrounding resin 13 so that the density of the fibers 11 is lower than that of the inner fibers 9. Lastly, in the crown section 8, the innermost longitudinal fibers 9 may be surrounded by outer fibers 11 that are dispersed to an even greater extent (thus making fiber density even lower than in the section 5), parallel with the axis 10 or interwoven in netted fashion in a plane or in space. The fibers 11 may be located even further from the axis 10 if the crown section 8 of the post is core shaped (FIGS. 3A, 3B).

As for the choice of materials for the different types of fibers 9 and/or 11, it is just as evident that the carbon may be of the High Modulus (HM) type, with an ultra-high elasticity modulus, or of the High Strength (HS) type, with a lower elasticity modulus, thus making it possible to use this additional parameter to modulate the local elasticity moduli of the post 1 to an even greater degree of precision.

Other combinations similar to the above may be obtained by substituting the carbon in the composite post structures indicated above by way of example with one of the following, listed in order of preference: quartz fibers; glass fibers; ceramic fibers; aramide fibers; polyethylene fibers; crystal “whiskers”; or carbon nanotubes.

The post 1 might also advantageously be structured in such a way as to have a central portion 12 made of a material that can be selectively removed from the body of the matrix 2 it forms part of. This would be very useful to facilitate extraction of the post 1 at a later stage, should the need to substitute it arise, without the risk of fracturing the post 1 in the process.

Removal of this material might be accomplished using a rotary instrument, a vibrating instrument or even an ultrasound instrument.

A lower strength central portion of the post 1 in the portion immediately around the axis 10 of the post 1 might be obtained in any of several ways.

A first way might be that of creating a sort of structural modifier capable of locally modifying the resistance properties of the post 1.

One way of obtaining a structural modifier of this type is that of blowing gas into the body of the matrix 2 along the axis 10 during the process of manufacturing the composite material.

The gas blown into the matrix body creates microcavities that reduce the local resistance of the material and facilitate removal when necessary.

Another way of obtaining a portion of more readily removable material is that of including soft powders along the longitudinal axis 10 of the post 1 during the process of moulding the body of the matrix 2.

Another way is that of simply reducing the concentration of solid fibers 9 and 11 in the nucleus immediately surrounding the axis 10 of the post 1. Obviously, the lower fiber concentration makes this portion locally richer in resin 13 which in turn means that the local matrix 2 material can be more easily and selectively removed from the rest of the material making up the post 1, which is richer in fiber.

Yet another way of creating a more readily removable portion 12 is to place the boron/tungsten fibers mainly in the area of the longitudinal axis 10 of the post: since boron is brittle, it can be removed using ultrasounds more easily than the fibers surrounding it, thereby creating an empty canal for the subsequent radial extraction of the post 1.

A yet further way of creating a more readily removable portion 12 is to simply place longitudinal fibers 9 in the vicinity of the axis 10 and interwoven fibers 11 peripherally.

The fibers 11, interwoven in a plane and/or in space, serve to contain the instrument used to remove the nucleus of parallel fibers 9.

In the plane perpendicular to the longitudinal axis 10, the fibers 9 are held together only by the relatively weak forces created by the adhesion of the matrix resin to the fibers themselves, and thus, in the longitudinal direction of the axis 10, the nucleus of fibers 9 is easier to penetrate than the oblique fibers 11 which, for mutual adhesion, can also count on the mechanical fit produced by the bi- or tri-axial weave.

When the central portion 12 of the post 1 is made from an added material different from that of the material of the matrix 2, the post 1 can be made partly radio-opaque for better identification using X-rays; or its flexural properties can be improved to reduce stress in the post 1 by inserting a soft, flexible portion 12, for example, of rubber, polytetrafluoroethylene (PTFE), polyamide or any other compatible material that is soft and flexible.

Further, pigments can be added to the matrix 2 in order to hide dark fibers (for example, carbon fibers) from view, or radio-opaque substances can be added to the matrix 2 to make the entire post easier to identify using X-rays.

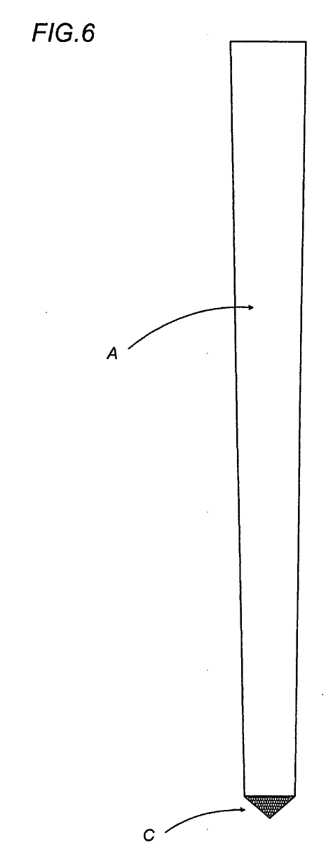

As to the proportioning of the posts according to the invention, the tables below show, with reference to FIGS. 4, 5 and 6, some possible and preferable examples of geometrical proportioning of the posts.

Cylindrical Posts (FIG. 4)

The total length ranges from 17 to 19 mm.

| | Diameter of | Length of | Taper of | Length of | Diameter of | |
|---|---|---|---|---|---|---|
| | cylindrical | cylindrical | median | median | apical | Length of |
| | portion | portion | portion | portion | portion | apical portion |
| Post | (A) | (A) | (B) | (B) | (C) | (C) |
| # 1 from | 1.2 | 14 | 0.15 | 3.5 | 0.675 | Flat tip |
| # 2 | | | | | | |
| # 3 to | 1.5 | 14 | 0.15 | 3.5 | 0.975 | |

CONICO-CYLINDRICAL POSTS (FIG. 5)
The total length ranges from 17 to 19 mm.

| | Diameter of | Length of | | Length of | Diameter of | |
|---|---|---|---|---|---|---|
| | cylindrical | cylindrical | Taper of | median | apical | Length of |
| | portion | portion | median | portion | portion | apical portion |
| Post | (A) | (A) | portion | (B) | (C) | (C) |
| # 1 from | 1.6 | 6.5 | 0.075 | 10.6 | 0.8 | 0.4 |
| # 2 | | | | | | |
| # 3 | | | | | | |
| # 4 to | 2.35 | 5.5 | 0.1 | 11.4 | 1.2 | 0.6 |

CONICAL POSTS (FIG. 6)
Length 17 and 19 mm

| | Max. | | | Diameter of | Length of |
|---|---|---|---|---|---|
| | diam. | Length of | Taper of | apical | apical |
| | of portion | portion | portion | portion | portion |
| Post | (A) | (A) | (A) | (C) | (C) |
| # 1 from | 1.3 | 17.025 | 0.02 | 0.95 mm | 0.475 mm |
| # 2 | | | | | |
| # 3 to | 1.6 | 16.875 | 0.02 | 1.25 mm | 0.625 mm |

The invention described has evident industrial applications and can be modified and adapted in several ways without thereby departing from the scope of the inventive concept. Moreover, all the details of the invention may be substituted by technically equivalent elements.

1. A supporting or strengthening element for dental prostheses or crown restorations made of a composite material consisting of a matrix (2) in which is embedded at least one solid phase (3) appropriately contained in it, wherein the length of the supporting or strengthening element can be divided into at least three different sections (4, 5, 8), the first of which (4), corresponding to the apical area of the tooth has predetermined mean cross section (6) and modulus of elasticity of the material it is made from; the second section (5) of the supporting or strengthening element (1), corresponding to the intermediate portion of the length of the tooth, having a mean cross section (7) that is larger than the mean cross section (6) of the first section (4), and local modulus of elasticity that is correlatively lower than the modulus of elasticity of the first section (4); the third section (8) of the supporting or strengthening element, corresponding to the crown area of the tooth, having the largest cross section and local modulus of elasticity that is the correspondingly lowest of the elasticity moduli of all the considered sections of the supporting or strengthening element; the elasticity moduli of the first, second and third sections (4, 5, 8) being made variable by varying from one section to the other of the supporting or strengthening element (1) at least the local structure of the solid phases embedded in the matrix (2), the elasticity moduli being determined in such a way as to confer flexural strength or rigidity that is as uniform as possible along the full length of the supporting or strengthening element.

2. The supporting or strengthening element according to claim 1, wherein the variations in the elasticity moduli from one to the other of the sections (4, 5, 8) of the supporting or strengthening element (1) are obtained by a combination of solid phases dispersed in the matrix (2), including a filament (9) or a bundle of fibers (9) running through at least one of the sections (4, 5, 8) longitudinally at the axis (10) of the tooth; and a plurality of fibers (11) on the outside of the filament (9) or bundle of fibers (9) dispersed at least in the third section (8) of the supporting or strengthening element (1).

3. The supporting or strengthening element according to claim 1, wherein the cross section of at least one of the sections (4, 5, 8) has an oblong shape.

4. The supporting or strengthening element according to claim 3, wherein the oblong shape is elliptic.

5. The supporting or strengthening element according to claim 3, wherein the oblong shape is polygonal.

6. The supporting or strengthening element according to claim 1, wherein the matrix (2) incorporates a portion (12) including reduced strength material (12), the portion (12) being located in the area around the longitudinal axis (10) of the supporting or strengthening element (1).

7. The supporting or strengthening element according to claim 6, wherein the material of the portion (12) incorporated in the matrix (2) around the longitudinal axis (10) of the supporting or strengthening element (1) is designed to be removed more easily than the surrounding areas of the matrix (2).

8. The supporting or strengthening element according to claim 7, wherein the removable material of the portion (12) includes polytetrafluoroethylene (PTFE) in the form of a tube or filament.

9. The supporting or strengthening element according to claim 7, wherein the removable material of the portion (12) includes rubber in the form of a tube or filament.

10. The supporting or strengthening element according to claim 7, wherein the removable material of the portion (12) includes silicone rubber in the form of a tube or filament.

11. The supporting or strengthening element according to claim 7, wherein the portion (12) of removable material is designed to be removed from the matrix (2) using a rotary tool.

12. The supporting or strengthening element according to claim 8, wherein the portion (12) of removable material is designed to be removed from the matrix (2) using an oscillating and/or vibrating tool.

13. The supporting or strengthening element according to claim 12, wherein the portion (12) of removable material is designed to be removed using an ultrasound frequency vibrating tool.

14. The supporting or strengthening element according to claim 6, wherein the portion (12) where the material can be selectively removed from the matrix (2) is obtained by applying to the matrix (2) a local structural modifier of the body of the matrix (2).

15. The supporting or strengthening element according to claim 14, wherein the structural modifier includes blowing a gas flow or gas bubbles into the material of the matrix (2) during the manufacturing process.

16. The supporting or strengthening element according to claim 14, wherein the removable material (12) includes powders added locally into the material of the matrix (2).

17. The supporting or strengthening element according to claim 16, wherein the powders added locally into the material of the matrix (2) are of soft material.

18. The supporting or strengthening element according to claim 17, wherein the soft material which the powders are made of is rubber.

19. The supporting or strengthening element according to claim 17, wherein the soft material which the powders are made of is soft resin.

20. The supporting or strengthening element according to claim 7, wherein the material (12) incorporated in the supporting or strengthening element (1) around the longitudinal axis (10) is radio-opaque.

21. The supporting or strengthening element according to claim 7, wherein the material (12) incorporated in the supporting or strengthening element (1) around the longitudinal axis (10) is less resistant to heat than the surrounding matrix.

22. The supporting or strengthening element according to claim 7, wherein the material (12) incorporated in the supporting or strengthening element (1) around the longitudinal axis (10) is inert.

23. The supporting or strengthening element according to claim 16, wherein the material (12) incorporated in the supporting or strengthening element (1) around the longitudinal axis (10) includes sintered powders.

24. The supporting or strengthening element according to claim 2, wherein the filament (9) or bundle of fibers (9) comprises carbon.

25. The supporting or strengthening element according to claim 2, wherein the filament (9) or bundle of fibers (9) comprises glass.

26. The supporting or strengthening element according to claim 2, wherein the filament (9) or bundle of fibers (9) comprises ceramic.

27. The supporting or strengthening element according to claim 2, wherein the filament (9) or bundle of fibers (9) comprises boron or boron/tungsten, where tungsten is the nucleus and boron the exterior of each single fibre.

28. The supporting or strengthening element according to claim 2, wherein the filament (9) or bundle of fibers (9) comprises quartz.

29. The supporting or strengthening element according to claim 2, wherein the filament (9) or bundle of fibers (9) comprises polyethylene.

30. The supporting or strengthening element according to claim 2, wherein the filament (9) or bundle of fibers (9) comprises aramide fibers.

31. The supporting or strengthening element according to claim 2, wherein the filament (9) or bundle of fibers (9) comprises silicon carbide.

32. The supporting or strengthening element according to claim 2, wherein the filament (9) or bundle of fibers (9) comprises metals or metal alloys.

33. The supporting or strengthening element according to claim 2, wherein the fibers (9; 11) are densely packed and in contact with each other.

34. The supporting or strengthening element according to claim 2, wherein at least the fibers (9; 11) in the third section (8) are spaced apart in order to reduce their numeric density.

35. The supporting or strengthening element according to claim 24, wherein at least one of the first, second and third sections (4, 5, 8) of the supporting or strengthening element (1) is axially crossed by fibers (9, 11) selected from the quartz, ceramic, glass, metal, boron, boron/tungsten hybrid, carbon, polyethylene, aramide fiber, or silicon carbide fibre families of material.

36. The supporting or strengthening element according to claim 35, wherein the fibers that axially cross the supporting or strengthening element (1) include pigments for chromatically contrasting the fibers (9, 11).

37. The supporting or strengthening element according to claim 24, wherein the outer fibers (11) in the third section (8) of the supporting or strengthening element (1) are parallel with the axis (10) of the supporting or strengthening element (1).

38. The supporting or strengthening element according to claim 24, wherein the outer fibers (11) in the third section (8) of the supporting or strengthening element (1) are parallel with each other and oblique with respect to the axis (10) of the supporting or strengthening element (1).

39. The supporting or strengthening element according to claim 24, wherein the outer fibers (11) in the third section (8) of the supporting or strengthening element (1) are oblique with respect to the axis of the supporting or strengthening element (1) and are interwoven.

40. The supporting or strengthening element according to claim 1, wherein the matrix (2) comprises a resin (13) selected from the polyester, epoxy, vinyl-ester, acrylic, bis-acrylic (Bis-GMA), cyano-ester, urethane methacrylate, phenolic, polyphenylene sulphide (PPS), polyetheretherketone (PEEK) or thermoplastic families of resins.

41. The supporting or strengthening element according to claim 1, wherein the matrix (2) comprises a resin (13) selected from the polyester, epoxy, vinyl-ester, acrylic, bis-acrylic (Bis-GMA), cyano-ester, urethane methacrylate, phenolic, polyphenylene sulphide (PPS), polyetheretherketone (PEEK) families of resins made composite by the addition of fillers such as glass, ceramic, colloidal silica, whiskers, nanosilica-coated whiskers and carbon nanotubes.

42. The supporting or strengthening element according to claim 1, wherein the matrix (2) comprises a metal-based constituent.

43. The supporting or strengthening element according to claim 1, wherein the matrix (2) comprises a ceramic-based constituent.

44. The supporting or strengthening element according to claim 1, wherein the first, second and third sections (4, 5, 8) are substantially identical in length.

45. The supporting or strengthening element according to claim 1, wherein the element is solidly preformed and in its original chemical and physical form before it is associated with a dental prosthesis or with an anatomical implant site.

46. The supporting or strengthening element according to claim 45, wherein the element has the form of a root canal post (20) for an anatomical dental structure.

47. The supporting or strengthening element according to claim 46, wherein the element has the form of a root canal post on which is there is formed as a single block with the post itself, a structure integrated in the third section (8) and constituting a core (20) designed to adequately support a prosthetic crown.

48. The supporting or strengthening element according to claim 46, wherein the element has the form of a root canal post on which is there is formed as a single block with the post itself, a structure integrated in the third section (8) and constituting a core (20) designed to adequately support a prosthetic crown and wherein said core (20) has at the base of it a system (21) by which it fits into the dental structure it is to form a part of.

49. The supporting or strengthening element according to claim 1, wherein the element has an essentially cylindrical shape, the diameter of the cylindrical portion of which may vary in a range between 1.2 and 1.5 mm; the length of the cylindrical portion (A) being around 70% of the total length of the post; the taper of the median portion (B) being around 0.15; the length of the median portion (B) being around 20% of the total length of the post; and the apical diameter being variable in a range of values between 50% and 60% of the diameter of the cylindrical portion (A).

50. The supporting or strengthening element according to claim 1, wherein the element has an essentially conico-cylindrical shape, the diameter of the cylindrical portion of which may vary in a range between 1.6 and 2.35 mm; the length of the cylindrical portion (A) being around 33% of the total length of the post; the taper of the median portion (B) being variable in range between 0.075 and 0.1 mm; the length of the median portion (B) being variable in range between 59% and 63% of the total length of the post; the apical diameter being around 50% of the diameter of the cylindrical portion (A), and the length of the apical portion being around 2.5% of the total length of the post.

51. The supporting or strengthening element according to claim 1, wherein the element has an essentially conical shape, with a maximum diameter that is variable in a range between 1.3 and 1.6 mm; the length of the portion (A) being around 100% of the total length of the post; the taper of the portion (A) being around 2%; the diameter of the apical portion (C) being variable in a range between 0.95 and 1.25 mm; and the length of the apical portion (C) being around 3% of the total length of the post.
